(19) United States
(12) Patent Application Publication
(10) Pub. No.: US 2025/0252257 A1
(43) Pub. Date: Aug. 7, 2025

(54) RESEARCH SUPPORT SYSTEM

(71) Applicant: Semiconductor Energy Laboratory Co., Ltd., Atsugi-shi (JP)

(72) Inventors: Kazuki HIGASHI, Atsugi (JP); Junpei MOMO, Sagamihara (JP)

(21) Appl. No.: 19/034,677

(22) Filed: Jan. 23, 2025

(30) Foreign Application Priority Data
Feb. 1, 2024 (JP) 2024-014443

(51) Int. Cl. G06F 40/279

(52) U.S. Cl. CPC G06F 40/279

(57) ABSTRACT

A research support system using a generative AI model, which can be sufficiently utilized in a chemical-related field, is provided. A user extracts a paper that is probably related or similar to a user's prompt from a large number of published papers and uses the paper as learning data. While looking at a screen of a display device, a user modifies the learning data to relabel the relationship between parameters, whereby a fine-tuned model is constructed. By utilizing the fine-tuned model, the research support system is constructed.

### BACKGROUND OF THE INVENTION

### 1. Field of the Invention

One embodiment of the present invention relates to a research support system, an information processing system, and an information processing method.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Specific examples of the technical field of one embodiment of the present invention disclosed in this specification include a semiconductor device, a display device, a light-emitting device, a power storage device, a memory device, a method for driving any of them, and a method for manufacturing any of them.

### 2. Description of the Related Art

In recent years, language models using neural networks have been actively developed, and a large language model (LLM) has particularly attracted attention. A large language model is a natural language processing model learned using a large amount of data. A large language model enables, for example, an interaction model for responding to user's instructions. In Non-Patent Document 1, Generative Pre-trained Transformer 4 (GPT-4, registered trademark) is disclosed as a large language model, and ChatGPT is disclosed as an interaction model.

By utilizing a large language model, the capability of a natural language processing model has been significantly increased. Meanwhile, it is difficult to incorporate and operate a language model by oneself in terms of facilities and costs due to hugeness of the language model. Accordingly, a language model provided by external service is generally used.

### REFERENCES

### Patent Document

[Patent Document 1] Japanese Published Patent Application No. 2020-102631

### Non-Patent Document

[Non-Patent Document 1] Yiheng Liu et al., Summary of ChatGPT/GPT-4 Research and Perspective Towards the Future of Large Language Models (Submitted on Apr. 4, 2023, [online] Internet URL: https://arxiv.org/abs/2304.01852

### SUMMARY OF THE INVENTION

In the case where a large language model is intended to be utilized for chemical-related research and development, it is difficult for chemical researchers to generate a generative artificial intelligence (AI) model because they lack specialized knowledge on generative AI. Similarly, it is difficult for generative AI engineers to generate a generative AI model because they lack specialized knowledge on chemistry.

Generative AI can generate answers to various questions; however, when an answer related to information that has not been learned by the generative AI is generated, a factually incorrect answer, i.e., hallucination might be generated. In particular, there is a small amount of data on a complex and specialized field of chemistry (a field of organic chemistry or inorganic chemistry), so that a database might not include words related to such a field and thus hallucination might be easily generated.

In view of the above, an object is to provide a research support system using a generative AI model, which can be sufficiently utilized in a chemical-related field.

It is difficult to obtain an answer (specifically, molecular information) to a prompt or a question in a highly specialized field (specifically, chemistry) only with a large language model that can be generally used. Thus, first, a user extracts a paper that is probably related or similar to a user's prompt from a large number of published papers and uses the paper as learning data. Note that the paper used for learning includes at least molecular information.

The user's prompt is also used as learning data.

The text data or the molecular information is to be introduced into a model and thus is preferably quantified. A known model (Junction Tree Variational Autoencoder (JT-VAE)) is used for quantifying the molecular information. JT-VAE is a model for generating a molecular structure, which employs VAE (unsupervised learning) for generating a molecular structure. Note that the JT-VAE model is learned in advance using a public database including a large number of molecular structures. Moreover, a known model (embedding) is used for quantifying the text data.

With use of these models, a fine-tuned model is generated. Mapping information (labeling data) on the degree of similarity, which is output when a prompt is input to the fine-tuned model, is generated. An image visualizing the mapping information is displayed on a display device for the user.

In the displayed mapping image, for example, a symbol of the prompt is placed at the center of a screen, and the linkage between the prompt and data similar to the prompt is shown.

While looking at the screen of the display device, the user modifies or retouches the mapping information to relabel the relationship (similar or not similar) between the parameters, whereby an optimal model (the fine-tuned model) can be constructed.

In a research support system disclosed in this specification, user's prompt data and a plurality of pieces of paper data including texts are input to a user device, and input data is divided into a plurality of pieces of text data. The text data is processed using an embedding model so as to be quantified and then output as an explanatory variable and output data is placed in a vector space. A data distribution diagram is output to a screen of the user device with the user's prompt data as a center. Data corresponding to the user's prompt data is estimated using a fine-tuned model learned by user's operation of modification of a parameter in the data distribution diagram displayed on the user device.

In the above structure, the user's prompt data is part of learning data of the fine-tuned model.

In the above structure, the paper data is part of learning data of the fine-tuned model.

In the above structure, the user's operation of modification is modification of a parameter value of a degree of similarity of data similar to the user's prompt data or addition of new text data considered by a user to have a high degree of similarity and a parameter value.

In this specification, a model is generated using AI, specifically, machine learning or deep learning, for example. The model is generated using a neural network, a support vector machine, or a random forest, for example.

With use of a language model, a research support system that provides a molecular structure corresponding to a user's prompt can be achieved.

### BRIEF DESCRIPTION OF THE DRAWINGS

In the accompanying drawings:

FIG. 1 is a schematic block diagram of a structure of a research support system showing one embodiment of the present invention;

FIG. 2 is an example of a flow chart showing one embodiment of the present invention;

FIG. 3 is a schematic view of a structure example of an information processing system showing one embodiment of the present invention;

FIG. 4 is an example of a flow chart showing one embodiment of the present invention;

FIG. 5 is an example of a block diagram showing one embodiment of the present invention;

FIG. 6A is an application example of a flow chart showing one embodiment of the present invention, and FIG. 6B is a block diagram showing one embodiment of the present invention;

FIG. 7 is a schematic view of a structure example of an information processing system showing one embodiment of the present invention;

FIG. 8 is a diagram showing part of mapping information output from a model;

FIG. 9 is an example of a display image before modification by user's operation; and

FIG. 10 is an example of a display image after modification by user's operation.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

### Embodiment 1

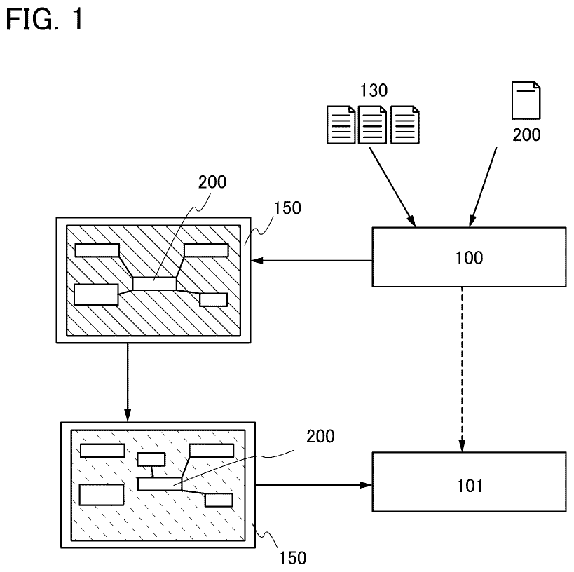

FIG. 1 is a block diagram showing generation of a pre-trained model, which is one of components for a research support system.

An example of generating a fine-tuned model 101 on the basis of a model 100 is shown below.

A display device 150 is used for fine tuning. The display device 150 is, specifically, a personal computer or an information processing terminal with a touch panel configured to be operated by touch input. While looking at an image displayed on the display device 150, a user modifies data (sets a parameter value of the degree of similarity) or adds data. The image displayed on the display device 150 is a mapping image visualizing data output from the model 100, and is preferably an image diagram that is easily understood by the user. An annotation, which is additional information, is additionally set, and the mapping image is generated on the basis of the annotation information. Specifically, a prompt 200, which is an item desired by the user, or a desired parameter is placed at the center of a screen as one symbol, and other parameters (texts) are placed so as to be distanced from the central symbol in accordance with the degree of similarity. FIG. 1 shows an example in which a white frame symbol is placed at the center of the image displayed on the screen of the display device 150. In the image, most similar parameters are linked to each other. A shorter distance from the center of the screen means higher similarity, and a line connects a target item and a related term.

In the case where the user performs modification to generate a modified display image, the fine-tuned model 101 reflecting the modification can be generated. With use of the display device, the user relabels the relationship (similar or not similar) between the parameters. In this manner, the fine-tuned model 101 is generated on the basis of the user's operation.

Note that a researcher who is the user generates teacher data for the model 100 in advance with use of a published paper 130 or the prompt 200. The researcher who is the user inputs the target item. The target item is a desired item, a research object, or the like, and the item name is “material reliability”, for example. The researcher who is the user inputs variables used as parameters, data related to the text or the term in the paper 130 is collected with use of a large language model, and the data is subjected to annotation processing.

The annotation processing refers to addition of an annotation, which is additional information, and the annotation can be associated with the positional relationship in the mapping image.

An embedding model is used as the model 100. In this embodiment, the mapping (network) image is generated using a model called multilingual-e5. Character strings are extracted by periods using the model 100, and the degree of similarity between the character strings is output using the embedding model.

Data input to the model 100 can be not only the paper 130 but also experimental data and measurement data actually obtained by the user and can also utilize data in public databases, specifically, molecular information, patents, chemical technical magazines, and the like. With use of specialized information as learning data, an optimal solution can be obtained as an output result of the model 100.

Moreover, with use of the fine-tuned model 101 generated on the basis of the user's operation, an optimal solution can be obtained with high accuracy.

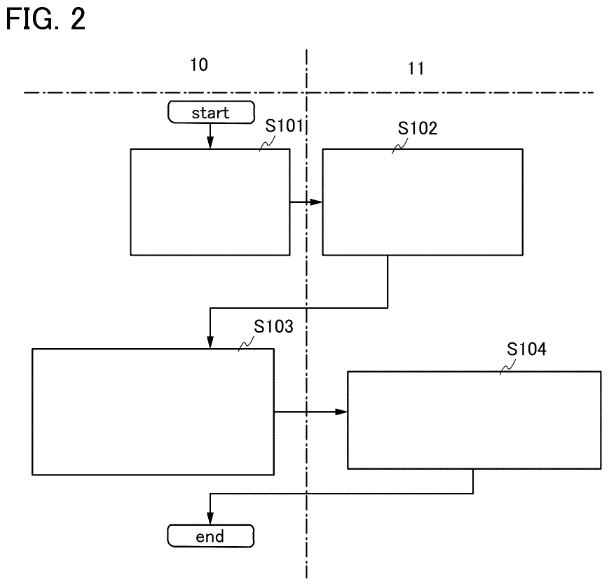

FIG. 2 shows an example of a flow chart showing a generation routine of the fine-tuned model 101, which shows one embodiment of the present invention.

In FIG. 2, in a step S101, paper data and prompt data are input to a user device 10. In a subsequent step S102, the paper data and the prompt data are transmitted from the user device 10 to a first server 11 and converted into vectors in the first server 11. Here, the vector refers to data of encoded description. In a subsequent step S103, the relationship between the texts is visualized (a network of the texts is constructed) in the user device 10 using the degrees of similarity of the vectors, and modified on the basis of user's operation. As a specific means of reflecting the modification made by the user in the fine-tuned model 101, ContrastiveLoss or MultipleNegativesRankingLoss can be used.

In a subsequent step S104, the fine-tuned model 101 reflecting the modification is generated in the first server 11.

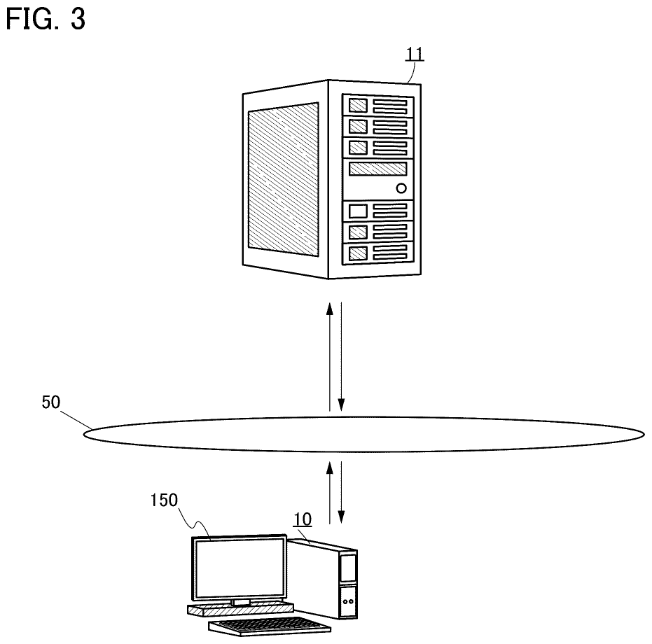

FIG. 3 shows structure examples of components of the information processing system of one embodiment of the present invention, a database, and a network connecting them.

As shown in FIG. 3, the information processing system (also referred to as the research support system) of one embodiment of the present invention includes at least the user device 10 and the first server 11.

As the user device 10, a desktop computer can be used, for example.

The user device 10 can receive data input by a user. Data output from the first server 11, a second server 12, or a third server 13 can be provided to the user.

Dedicated application software or a web browser operates, for example. Via any of them, the user can access the information processing system. Accordingly, the user can receive service using the information processing system of one embodiment of the present invention.

For example, a workstation, a server computer, or a supercomputer can be used as the first server 11. The first server 11 preferably has a function of a parallel computer. By using the first server 11 as a parallel computer, large-scale computation necessary for AI learning and inference can be performed, for example. The first server 11 can perform processing using a natural language processing model using AI.

For example, it is possible to execute processing using a natural language model (natural language processing) such as Bidirectional Encoder Representations from Transformers (BERT), Text-to-Text Transfer Transformer (T5), GPT-3, GPT-3.5, GPT-4 (registered trademark), Language Model for Dialogue Applications (LaMDA), Pathways Language Model (PaLM), or Llama2.

In the information processing system, predetermined data is transmitted between the user device 10 and the first server 11 through a network 50. In the information processing system, the user device 10 and the first server 11 operate in conjunction with each other, whereby the fine-tuned model 101 can be generated.

### Embodiment 2

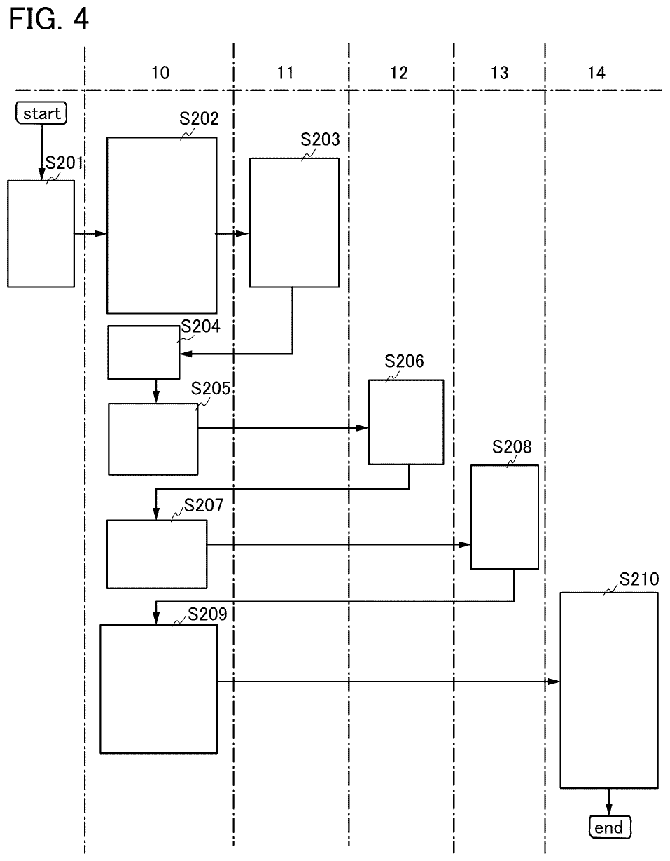

FIG. 4 shows an example of a flow chart of formation of a regression model in a fourth server 14, which shows one embodiment of the present invention. In this example, a plurality of servers (the first server 11, the second server 12, the third server 13, and the fourth server 14) are used, as shown in FIG. 4.

In FIG. 4, in a step S201, a user selects a paper or a document 140 and inputs information (electronic data including at least a molecular structure and a text) to the user device 10. In a subsequent step S202, an extraction prompt is generated in the user device 10 on the basis of the input document data and prompt data. In a subsequent step S203, molecular representation and description are extracted and divided in the first server 11. In a subsequent step S204, a list is generated in the user device 10.

In a subsequent step S205, the description is input to the second server 12 with use of the user device 10. In a subsequent step S206, the description is converted into a vector in the second server 12. In a subsequent step S207, the molecular representation is input to the third server 13 with use of the user device 10. In a subsequent step S208, the molecular representation is converted into a vector in the third server 13. In a subsequent step S209, a data set is generated in the user device 10 and then input to the fourth server 14 as teacher data. In a subsequent step S210, learning of a regression model 110 is performed so that the molecular vector can be predicted from the text vector.

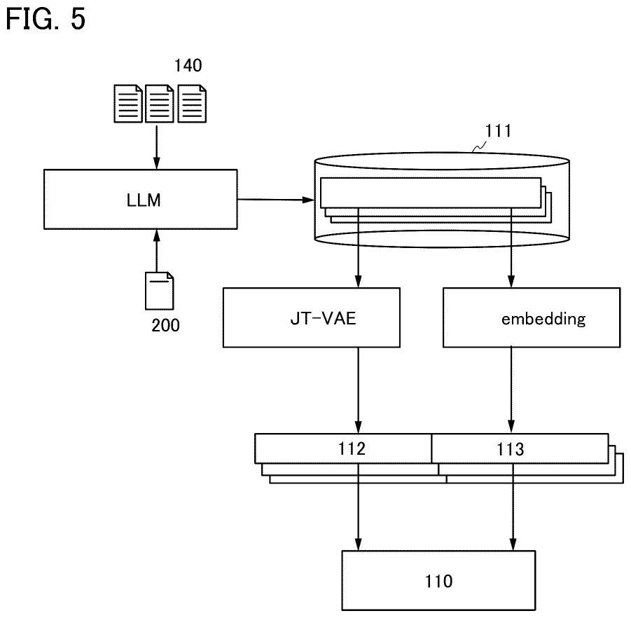

FIG. 5 shows an example of a block diagram of the regression model 110. The regression model 110 is a model before user's operation.

As the teacher data for the regression model 110, a molecular structure string (corresponding to the molecular representation) and a character string (corresponding to the description) related thereto are extracted separately with use of a large language model (an LLM model), and then stored in a database 111. The database 111 stores language information other than the document 140 in advance. The document 140 selected by the user and the prompt 200 are added as data information to the database 111 with use of a large language model (an LLM model).

Using a model for quantifying a molecular structure (typically, JT-VAE), the molecular structure is quantified and then output as an objective variable 112, and using an embedding model, the character string is quantified and then output as an explanatory variable 113. The document 140 prepared by the user including a larger number of molecular structures includes a larger number of texts corresponding to the molecular structures, which increases the amount of teacher data and enables the regression model 110 to include rich teacher data.

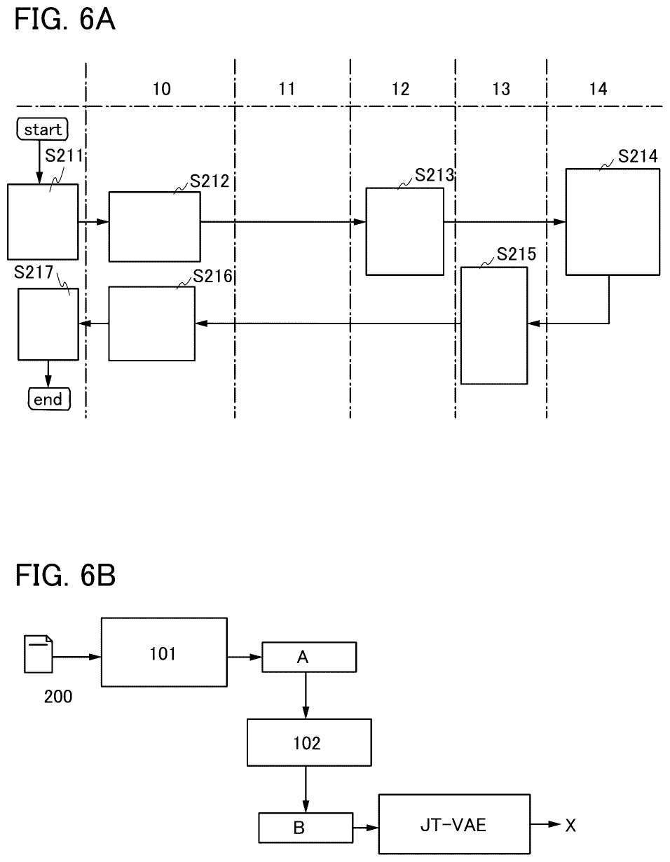

FIG. 6A shows an example of a flow chart showing a routine of an application example using the fine-tuned model 101, which shows one embodiment of the present invention. Note that FIG. 6A shows an example in which the fine-tuned model 101 is generated in the second server 12 with use of the first server 11 and thus a new regression model is generated in the fourth server 14, which is another server.

First, a new regression model is generated so as to associate the vector space of the fine-tuned model 101 with the vector space of a model. The new regression model is generated in the fourth server 14.

In FIG. 6A, in a step S211, a user inputs a prompt to the user device 10. In a subsequent step S212, the prompt is input to the second server. In a subsequent step S213, the prompt is converted into a vector in the second server 12. In a subsequent step S214, a molecular vector is predicted from a text vector in the fourth server 14. In a subsequent step S215, the molecular vector is converted into molecular representation in the third server 13. In a subsequent step S216, the user device 10 displays the molecular representation. In a subsequent step S217, the user confirms the molecular representation displayed on a screen of the user device 10.

FIG. 6B is a schematic view of information processing using the fine-tuned model 101, in which the prompt 200 is input, estimation is performed, and then a molecular structure X is output.

As shown in FIG. 6B, a user inputs the prompt 200 to the fine-tuned model 101, whereby a sequence A corresponding to the prompt 200 is output from the fine-tuned model 101. The sequence A is input to a regression model 102, whereby a sequence B is output. The sequence B is input to a model (typically, JT-VAE), whereby the sequence B can be converted into the molecular structure X. The regression model 102 to which the sequence A is input is generated so as to associate the vector space of the fine-tuned model 101 with the vector space of the model (JT-VAE). While looking at the display device 150 and operating the user device 10, the user can perform input and output and confirm display, as shown in FIG. 6B.

As described above, by inputting the prompt 200 to the fine-tuned model 101, the user can obtain the molecular structure X that gives a tip on research and development. Utilizing such a system as a research support system enables efficient research and development.

With use of various prompts 200, the user can obtain various candidates for a molecular structure that gives a tip on research and development.

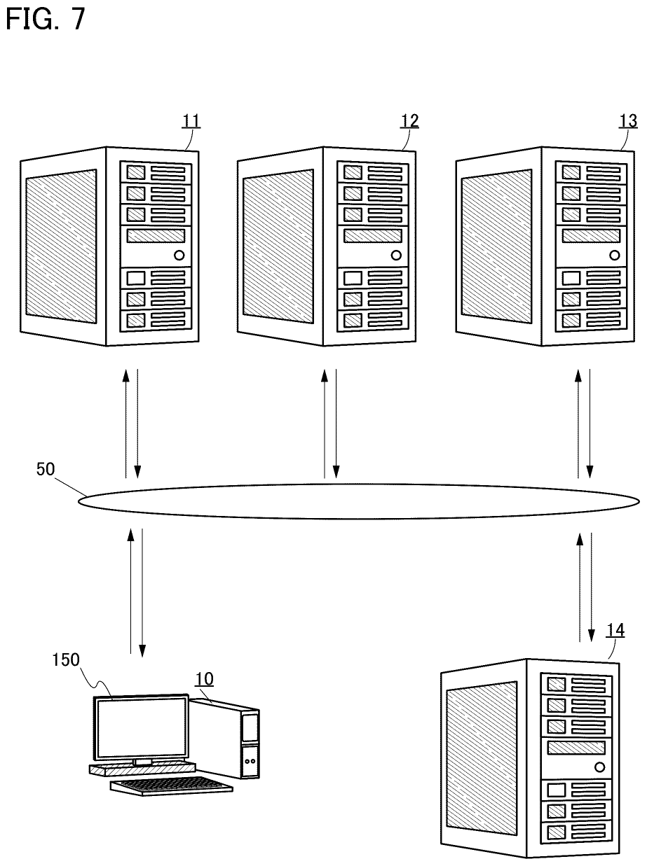

FIG. 7 shows structure examples of components of the information processing system of one embodiment of the present invention, databases, and a network connecting them.

Note that in FIG. 7, the same portions as those in FIG. 3 are denoted by the same reference numerals. FIG. 7 shows an example in which a fine-tuned model is constructed in the second server 12, and the regression model 102 is constructed in the fourth server 14.

For example, a workstation, a server computer, or a supercomputer can be used as each of the second server 12, the third server 13, and the fourth server 14. The fourth server 14 preferably has a function of a parallel computer. By using the fourth server 14 as a parallel computer, large-scale computation necessary for AI learning and inference can be performed, for example.

This embodiment can be freely combined with any of the other embodiments.

### EXAMPLE

Hereinafter, an example of generating a fine-tuned model will be described on the basis of the drawings.

In this example, an example of generating a fine-tuned model using Patent Document 1 (Published Patent Document No. 2020-102631) that has been already published is described.

First, data on text data in the patent document is extracted. The data is divided so that one text is one component. After that, the degree of similarity of each text is calculated and then used as an annotation, which is additional information. A mapping (network) image is generated using a model called multilingual-e5. One text is linked to another text most similar thereto. All texts are similarly linked to each other in a round-robin manner. By this linking processing, a plurality of groups of linked texts are formed.

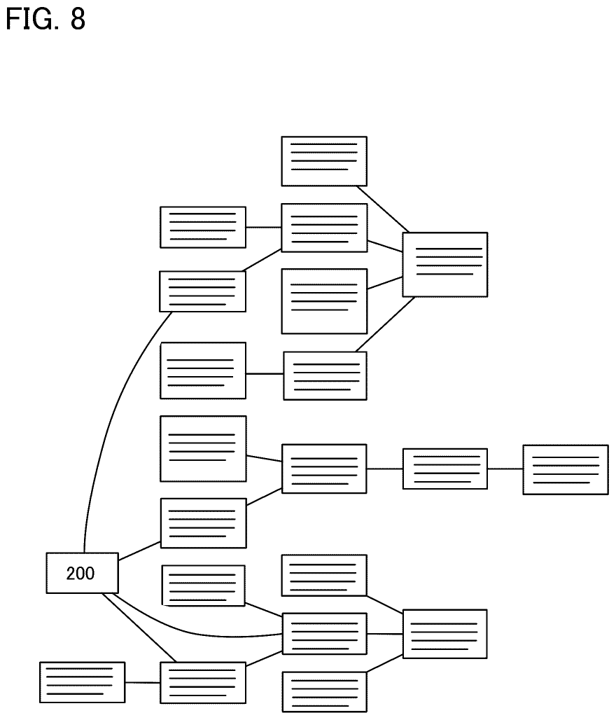

FIG. 8 shows the plurality of groups. FIG. 8 shows an example in which one text is displayed in one block, and shows part of full-text data. By scrolling a screen, a user can check the linkage between blocks each including one text in the full-text data.

Then, as the prompt 200, a text “A high-color-purity material” is used. The degrees of similarity of the texts with respect to the text “A high-color-purity material” are calculated. On the basis of the calculation results, the prompt 200 is linked to the top four texts, and the texts are placed in the descending order of the degree of similarity such that the text “A high-color-purity material” is placed at the center. Table 1 below shows part of the results. For simplicity, Table 1 shows only the results of the top seven texts among the all texts.

TABLE 1

| | | Degrees of |
|---|---|---|
| | Texts | similarity |
| T1 | Moreover, in terms of color purity, . . . | 0.871665418 |
| T2 | In addition, these materials possibly . . . | 0.850780666 |
| T3 | Therefore, the light-emitting elements 2 to 4 are . . . | 0.849915087 |
| T4 | Therefore, high resolution is easily achieved . . . | 0.846390367 |
| T5 | Specifically, molybdenum oxide is particularly | 0.840946198 |
| | preferable. | |
| T6 | The substances described here mainly have 10⁻⁶ | 0.840005517 |
| | cm²/Vs or higher . . . | |
| T7 | That is, light-emission efficiency 3 to 4 times that of a | 0.832636416 |
| | fluorescent compound . . . | |

Next, whether the top four texts (T1, T2, T3, and T4) are each technically close to the text “A high-color-purity material” is judged. Each of the texts in the second and fourth places (T2 and T4) among the top four texts and the text “A high-color-purity material” are technically less relevant to each other, and thus are unlinked. Meanwhile, a text “Note that these emission spectra were each confirmed to have a small half width.”, which is not in the top four texts and is ranked 107^{th} (T107) regardless of its high degree of technical relevance, is additionally linked to the text “A high-color-purity material”.

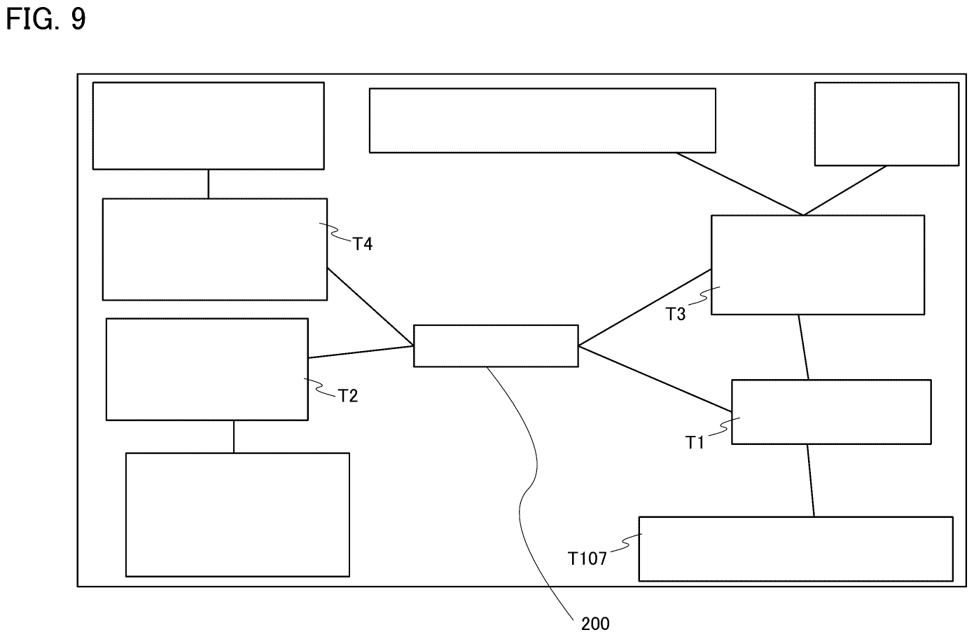

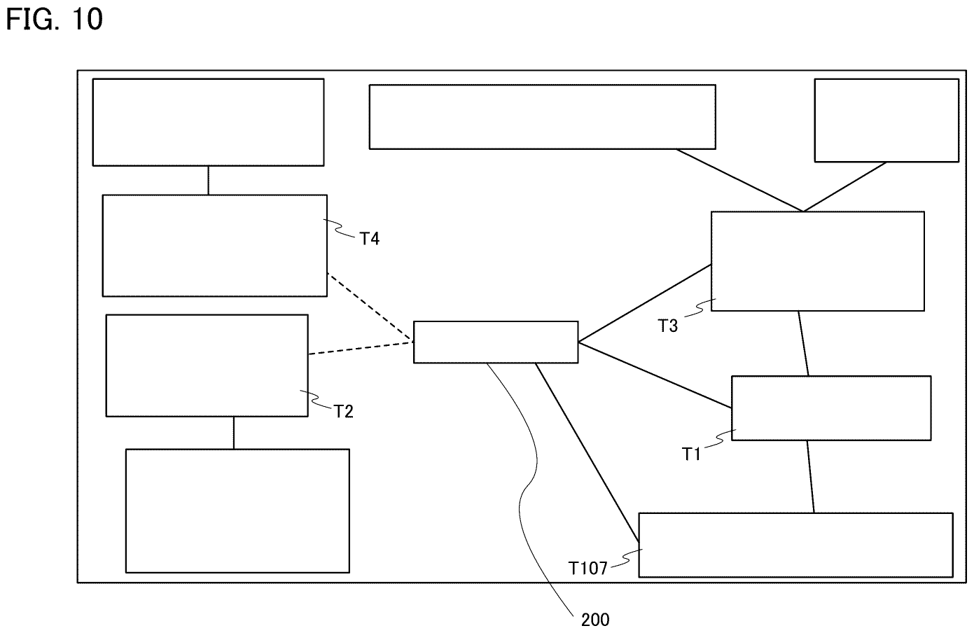

FIG. 9 shows an example of an unmodified image, and FIG. 10 shows an example of a modified image. The images shown in FIG. 9 and FIG. 10 correspond to data distribution diagrams each including prompt (200) data at the center. A fine-tuned model can be generated on the basis of data corresponding to the modified image.

By performing the above-described information processing, the fine-tuned model can be generated.

This application is based on Japanese Patent Application Serial No. 2024-014443 filed with Japan Patent Office on Feb. 1, 2024, the entire contents of which are hereby incorporated by reference.

What is claimed is:

1. A research support system,
wherein user's prompt data and a plurality of pieces of paper data comprising texts are input to a user device, and input data is divided into a plurality of pieces of text data,
wherein the plurality of text data is processed using an embedding model so as to be quantified and then output as an explanatory variable and output data is placed in a vector space,
wherein a data distribution diagram is output to a screen of the user device with the user's prompt data as a center, and
wherein data corresponding to the user's prompt data is estimated using a fine-tuned model learned by user's operation of modification of a parameter in the data distribution diagram displayed on the user device.

2. The research support system according to claim 1,
wherein the user's prompt data is part of learning data of the fine-tuned model.

3. The research support system according to claim 1,
wherein the plurality of pieces of paper data is part of learning data of the fine-tuned model.

4. The research support system according to claim 1,
wherein the modification is modification of a first parameter value of a degree of similarity of data similar to the user's prompt data or addition of new text data considered by a user to have a high degree of similarity and a second parameter value.

5. A research support system,
wherein prompt data and a plurality of pieces of text data are input to a device,
wherein the plurality of pieces of text data are quantified using an embedding model,
wherein the quantified data is output as an explanatory variable and output data is placed in a vector space,
wherein a data distribution diagram is displayed on a screen using the prompt data as a center, and
wherein data corresponding to the prompt data is estimated using a fine-tuned model learned by modification of a parameter in the data distribution diagram displayed on the screen.

6. A research support system,
wherein prompt data and a plurality of pieces of text data are input to a device,
wherein the plurality of pieces of text data are quantified using a neural network,
wherein the quantified data is output as an explanatory variable and output data is placed in a vector space,
wherein a data distribution diagram is displayed on a screen using the prompt data as a center, and
wherein data corresponding to the prompt data is estimated using a fine-tuned model learned by manual modification of a parameter in the data distribution diagram displayed on the screen.
